(19) United States
(12) Patent Application Publication
(10) Pub. No.: US 2023/0315642 A1
(43) Pub. Date: Oct. 5, 2023

(54) CACHE ACCESS FABRIC

(71) Applicant: Intel Corporation, Santa Clara, CA (US)

(72) Inventors: Leon POLISHUK, Haifa (IL); Ayan MANDAL, Bangaluru (IN); Neetu JINDAL, Kurukshetra (IN); Eran SHIFER, Tel Aviv (IL); Keren MELAMED, Binyamina (IL)

(21) Appl. No.: 18/207,602

(22) Filed: Jun. 8, 2023

(51) Int. Cl. G06F 12/0877

(52) U.S. Cl. CPC G06F 12/0877; G06F 2212/60

(57) ABSTRACT

Examples described herein relate to a cache fabric that includes a first layer of a group of routers and includes a second layer of a plurality of clusters of cache controllers. A router of the group of routers can be accessible via an interface that is to receive a memory access request from a processor and select from a group of cache controllers based on a cluster identifier and memory address and provide the memory access request to the selected group of cache controllers. The selected group of cache controllers can receive the memory access request and service a memory access request from a cache device or forward the memory access request to a second cache controller associated with the cache device or a second cache device.

### BACKGROUND

With constant growth of a number of cores in a server, fabrics that communicatively couple cores to cache devices have increasing bandwidth requirements. A mesh fabric can allow connection of cores to a cache device to access an entirety of the cache. For example, the mesh fabric allows a Last Level Cache (LLC) to be accessible by connected cores.

### BRIEF DESCRIPTION OF THE DRAWINGS

FIGS. 1A and 1B depict example systems.

FIG. 2 depicts an example system.

FIGS. 3A and 3B depict example systems.

FIG. 4 depicts an example process.

FIG. 5 depicts an example system.

### DETAILED DESCRIPTION

Power usage of mesh fabrics can increase as mesh fabrics connect increasing numbers of processors to cache devices. At least to potentially reduce or limit power usage of a cache fabric that connects processor cores to one or more cache devices, various examples provide a cache fabric with a first layer of a group of routers and a second layer of a plurality of clusters of cache controllers. A router of the group of routers can be accessible via an interface that is to receive a memory access request from a processor and select from a group of cache controllers based on a cluster identifier and memory address and provide the memory access request to the selected group of cache controllers. The selected group of cache controllers can receive the memory access request and service a memory access request from a cache device or forward the memory access request to a second cache controller associated with the cache device or a second cache device.

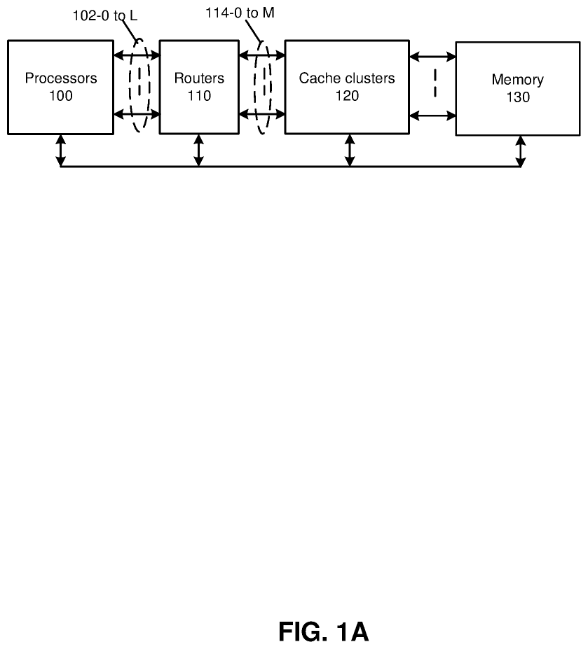

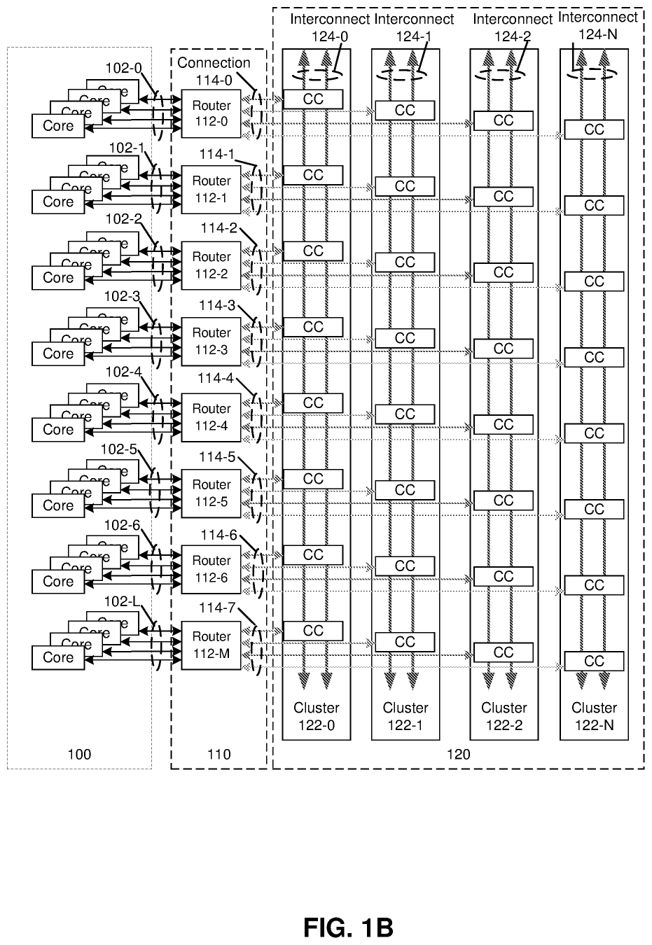

FIG. 1A depicts an example overview of a system. Processors 100 can include one or more processor cores configured to process a specific instruction set. In some examples, instruction sets may facilitate Complex Instruction Set Computing (CISC), Reduced Instruction Set Computing (RISC), or computing via a Very Long Instruction Word (VLIW). Processors 100 may process different instruction sets, which may include instructions to facilitate the emulation of other instruction sets. Processors 100 may also include other processing devices, such as a Digital Signal Processor (DSP). Processors 100 can be part of a central processing unit (CPU) or graphics processing unit (GPU).

A register file (not shown) can be additionally included in processors 100 and may include different types of registers for storing different types of data (e.g., integer registers, floating point registers, status registers, and an instruction pointer register). Some registers may be general-purpose registers. In some examples, one or more of the cores can include a memory controller (not shown) that is to provide memory access request communications to a memory device and other components (e.g., routers 110). In some examples, a memory access request can specify one or more of: an virtual or physical address associated with a memory device (e.g., memory 130) to read-from or write-to or a cache cluster identifier to identify a cluster among cache clusters 120.

In some examples, one or more of processors 100 can be coupled with one or more interface buses 102-0 to 102-L, where L is an integer, to transmit communication signals such as address, data, or control signals between a core and one or more of routers of routers 110. The one or more interface buses 102-0 to 102-L can include a processor bus, such as a version of the Direct Media Interface (DMI) bus. However, processor busses are not limited to the DMI bus, and may include one or more Peripheral Component Interconnect interfaces (e.g., Peripheral Component Interconnect express (PCIe), Universal Chiplet Interconnect Express (UCIe)), memory busses or interfaces (e.g., Compute Express Link (CXL), or other types of interfaces.

Cache clusters 120 can include one or more cache controllers and cache (e.g., one or more registers, one or more cache devices (e.g., level 1 cache (L1), level 2 cache (L2), level 3 cache (L3), last level cache (LLC)), volatile memory device, non-volatile memory device, or persistent memory) (not shown), which may be shared among processors 100 using cache coherency techniques. If data referenced by a memory access request is stored in a cache device (e.g., cache hit), the cache device can provide the data to a requester processor. If data referenced by a memory access request is not stored in a cache device (e.g., cache miss), the cache controller or cache device can forward the request to a memory controller of memory device 130. A home agent (HA) or caching and home agent (CHA) (not shown) can perform data coherency among cache devices and memory devices. In some examples, for particular addressable memory ranges accessible to particular CPUs, HA can attempt to achieve data consistency among the memory devices and caches. Memory device 130 can include one or more volatile or non-volatile memory devices. Memory 130 can provide the data to a requester processor via cache clusters 120 or another connection.

Communications between components of FIG. 1A can take place using conductors that provide die-to-die communications; chip-to-chip communications; circuit board-to-circuit board communications; and/or package-to-package communications. A die-to-die communications can utilize Embedded Multi-Die Interconnect Bridge (EMIB) or an interposer. Components of FIG. 1A can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers.

FIG. 1B depicts an example system. One or more cores of processors 100 can provide a memory access request to an associated router among routers 112-0 to 112-M, where M is an integer. In some examples, a source core can calculate a destination cache controller and cache device that manages a specific address associated with the memory access request. For example, routers 112-0 to 112-M can perform decoding of memory access requests to identify a cluster among clusters 122-0 to 122-N, where N is an integer, that corresponds to a cluster of cache controllers and cache devices (e.g., cluster 122-0 to 122-N, where N is an integer) that potentially store data associated with a memory address provided by the memory access request. A router can utilize a cross bar, one or more multiplexers, or other interface to forward the memory access request to the identified cluster.

Clusters 120 can provide an interconnect between the output of routers 110 and cache controllers and cache devices and, potentially, memory devices. One or more of clusters 122-0 to 122-N can include one or more cache controllers and cache devices (CC). A cluster can be mapped to a subset of memory addresses, based on hash function or other allocation, to allocate memory addresses or spans of contiguous memory addresses to particular clusters. In some examples, the receiver cache controller of a CC can manage a specific address associated with the memory access request. A cache controller of a CC can receive the memory access request and determine if the cache controller manages memory addresses in a range that includes a memory address associated with the memory access request or another cache controller manages memory addresses in a range that includes a memory address associated with the memory access request. Based on the cache controller managing memory addresses in a range that includes a memory address associated with the memory access request, the cache controller can determine if an associated cache stores or does not store data associated with the memory access request. For a cache hit, the cache controller can provide the data to the requester core. In the case of a cache hit, data can traverse a path to the core via an interconnect through the cluster (e.g., one of 124-0 to 124-N) and then through the originating router (e.g., one of 112-0 to 122-M) to the requestor core. For a cache miss, the cache controller can provide the memory access request, or portion thereof, to a home agent or caching and home agent (not shown) to retrieve and provide the data to the source core. A home agent or caching and home agent (not shown) can perform data coherency among cache devices and memory devices so that data provided to a requester core is a current version.

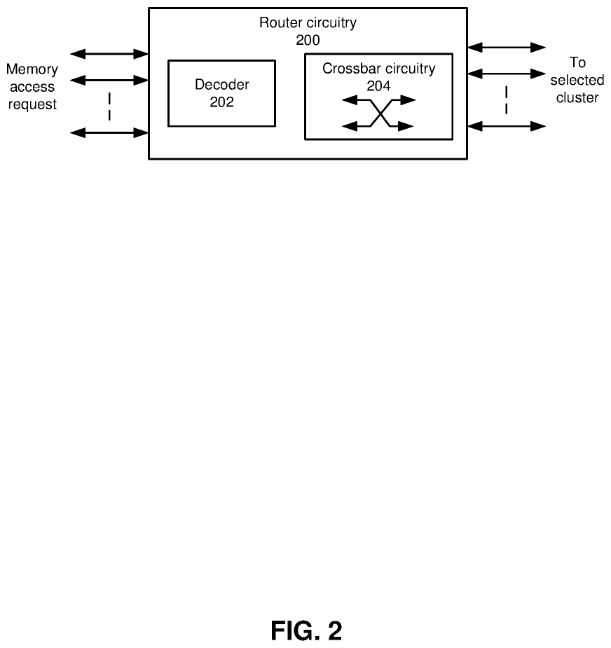

FIG. 2 depicts an example router circuitry. Decoder 202 can receive a memory access request and based on a configuration from an operating system (OS), system administrator, orchestrator, or other entity, select an output line connected to a target cluster based on an address associated with a memory access request. For example, decoder 202 can access a configuration that specifies: a cluster and output line for a particular virtual or physical memory address range or values. In some examples, a core can specify a memory address and cluster number and decoder 202 can select an output line in crossbar circuitry 204 to the target cluster based on address and cluster number.

Crossbar circuitry 204 can connect one or more of a number of cores to a number of different cache controllers in different clusters. For example, crossbar circuitry 204 can connect one or more of 4 cores to 4 different cache controllers in different clusters. Crossbar circuitry 204 can include one or more 4×4 crossbars, four 2×2 crossbars, or other configurations. Crossbar circuitry 204 can enqueue received memory access requests prior to output to a target cluster and output memory access requests based on ordering (e.g., ordering of requests received from different transfers such as first in first out), arbitration (e.g., round robin selection from queues or source cores, round robin selection from queues or source cores without head of line blocking, higher priority memory access requests are released before lower priority memory access requests), or other policies. Crossbar circuitry 204 can enqueue received responses to memory access requests (e.g., data or other control messages) prior to output to a core based on ordering (e.g., first in first out), arbitration (e.g., higher priority memory access requests are released before lower priority memory access requests), or other policies.

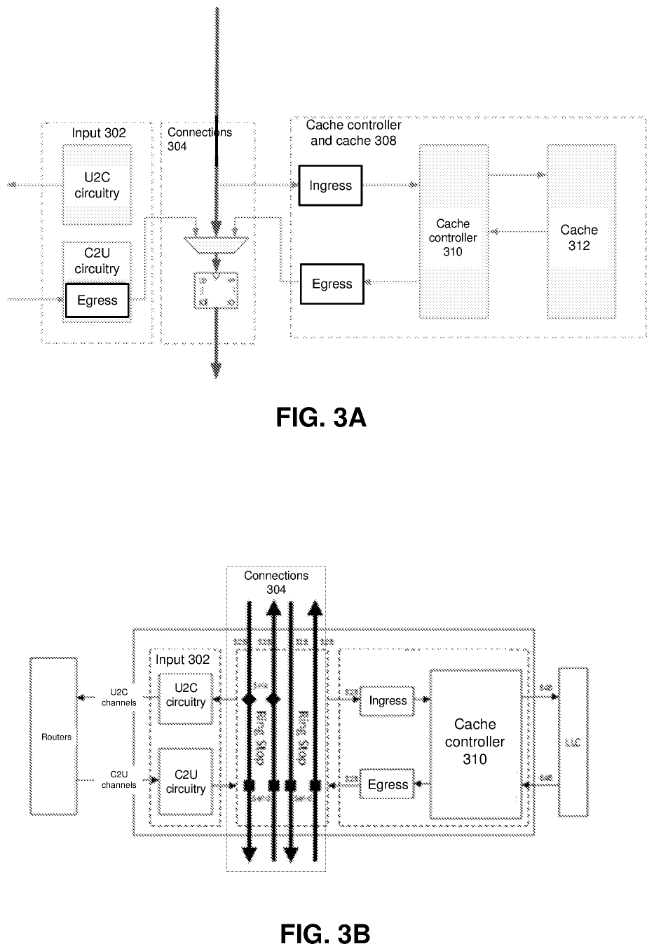

FIG. 3A depicts an example cache controller system. Input 302 can include a U2C (e.g., uncore to core) circuitry to provide communications (e.g., memory access requests, data, snoops, responses, interrupts, or control signals) to a router or crossbar for forwarding to a processor via an interface. Input 302 can include a C2U (e.g., core to uncore) circuitry to provide communications (e.g., memory access requests, data, snoops, responses, interrupts, or control signals) from a router or crossbar to connections 304 via an interface. An uncore (e.g., system agent) can include or more of a memory controller, a shared cache (e.g., last level cache (LLC)), a cache coherency manager, arithmetic logic units, floating point units, core or processor interconnects, Caching/Home Agent (CHA), interface circuitry (e.g., fabric, memory, device), and/or bus or link controllers. An uncore can provide one or more of: direct memory access (DMA) engine connection, non-cached coherent master connection, data cache coherency between cores and arbitrates cache requests, or Advanced Microcontroller Bus Architecture (AMBA) capabilities.

Connections 304 can provide communication between different cache controllers of a cluster using an interface. For example, one or more interfaces can operate in a manner consistent with Inter-Integrated Circuit (I2C) Protocol, Serial Peripheral Interface (SPI), or other protocols. At ingress, cache controller and cache 308 can receive memory access requests or snoops from processors. A snoop can be used to determine if cache coherency is maintained among cache devices and identify whether cache devices store content identified by a memory address. At egress, cache controller and cache 308 can forward memory access requests to another cache controller and cache in a same cluster, provide the memory access request to a home agent or caching and home agent, or provide data from cache 312 to be sent to a processor that issued a memory access request for the data. Cache controller 310 can include or access HA or CHA circuitry to perform data coherence checks to identify and request and receive revised data from other cache devices or memory devices. Cache controller 310 can utilize scoreboard circuitry to track received memory access requests, attempt to maintain order of operations, and track status of memory access requests or snoops (e.g., completed, forwarded, incomplete, time out (e.g., no response received), or others).

FIG. 3B depicts an example cache controller system. The operation of cache controller and cache (e.g., LLC) can be similar to that of the system of FIG. 3A.

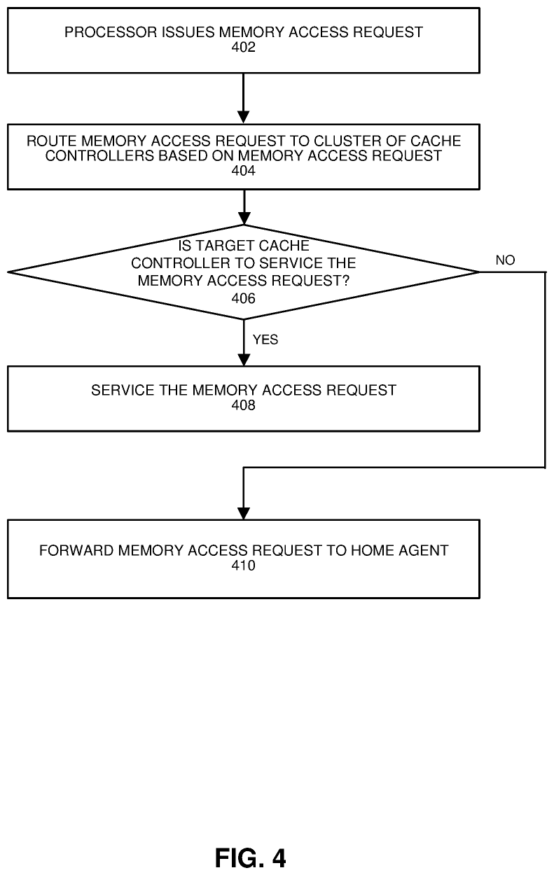

FIG. 4 depicts an example process. The process can be performed by a processor using a group of routers and a plurality of clusters of cache controllers. At 402, a processor can issue memory access request to an associated router. In some examples, the memory access request is associated with one or more of: a read or write request, memory address, and target cluster. At 404, the router can route the memory access request to a target cluster. In some examples, the router can be one of a plurality of routers, where one or more of the plurality of routers is coupled to different cache controllers in different clusters. For example, the router can select a particular output line that is connected to the target cluster to forward the memory access request to a cache controller in the target cluster.

At 406, a determination can be made if the cache controller in the target cluster can service the memory access request. For example, the cache controller in the target cluster can service the memory access request based on the memory access request being associated with an address assigned to the cache controller. Based on the cache controller in the target cluster servicing the memory access request, the process can proceed to 408. At 408, based on a cache hit in a cache device associated with the cache controller, the cache controller can service the memory access request by providing data from the cache device to the requester processor.

At 406, based on the cache controller in the target cluster not servicing the memory access request, the process can proceed to 410. At 410, based on a cache miss in a cache device associated with the cache controller, the cache controller can forward the memory access request to a home agent (HA) or caching and home agent (CHA) to manage access of the data for the memory access request from a memory or storage device. In some examples, at 410, the cache controller in the target cluster can forward the memory access request to a second cache controller in the same cluster using an output line in the target cluster for the second cache controller to service the memory access request. For example, the target cluster can include one or more output lines that communicatively couple together different cache controllers.

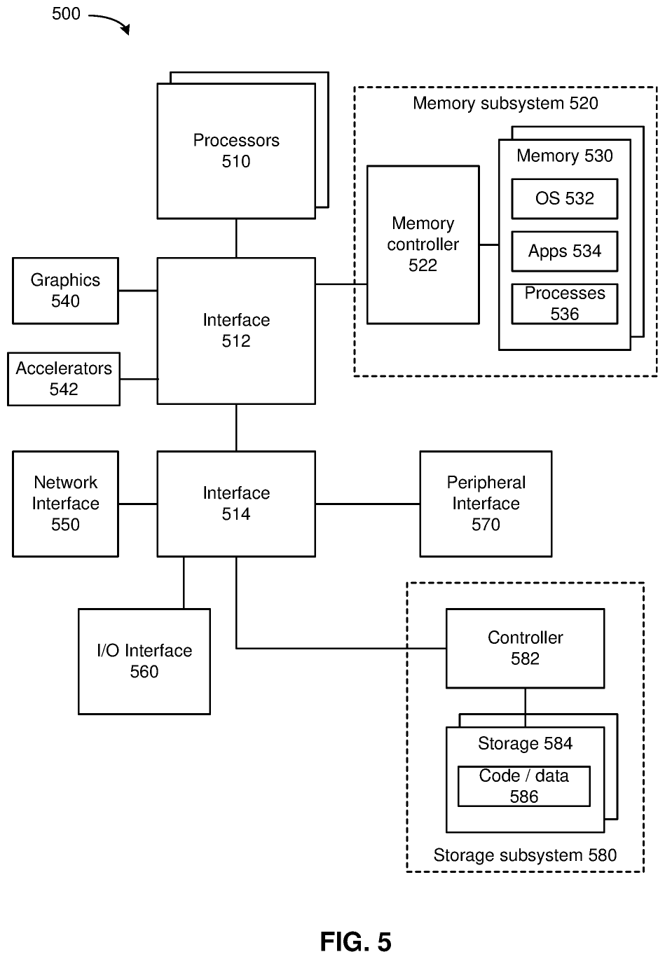

FIG. 5 depicts a system. The system can use a multiple routers and multiple cluster systems to forward memory access requests, as described herein. System 500 includes processors 510, which provides processing, operation management, and execution of instructions for system 500. Processors 510 can include any type of microprocessor, central processing unit (CPU), graphics processing unit (GPU), XPU, processing core, or other processing hardware to provide processing for system 500, or a combination of processors. An XPU can include one or more of: a CPU, a graphics processing unit (GPU), general purpose GPU (GPGPU), and/or other processing units (e.g., accelerators or programmable or fixed function FPGAs). Processors 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processors 510 can include one or more processor sockets.

In some examples, interface 512 and/or interface 514 can include a switch (e.g., CXL switch) that provides device interfaces between processors 510 and other devices (e.g., memory subsystem 520, graphics 540, accelerators 542, network interface 550, and so forth).

In one example, system 500 includes interface 512 coupled to processors 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. In some examples, interface 512 and/or interface 512 can include a multiple routers and multiple cluster systems to forward memory access requests to memory subsystem 520 and/or storage subsystem 580, as described herein.

Accelerators 542 can be a programmable or fixed function offload engine that can be accessed or used by a processors 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 542 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processors 510, or data values to be used in executing a routine. Memory subsystem 520 can include one or more memory devices 530 such as read-only memory (ROM), flash memory, one or more varieties of random access memory (RAM) such as DRAM, or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Applications 534 and/or processes 536 can refer instead or additionally to a virtual machine (VM), container, microservice, processor, or other software. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. Memory controller 522 could be a physical part of processors 510 or a physical part of interface 512. For example, memory controller 522 can be an integrated memory controller, integrated onto a circuit with processors 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on one or more processors sold or designed by Intel®, ARM®, AMD®, Qualcomm®, IBM®, Nvidia®, Broadcom®, Texas Instruments®, among others. In some examples, OS 532 and/or a driver can configure multiple routers and multiple cluster systems to forward memory access requests to memory subsystem 520 or storage subsystem 580, as described herein.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

In some examples, network interface 550 can be implemented as a network interface controller, network interface card, a host fabric interface (HFI), or host bus adapter (HBA), and such examples can be interchangeable. Network interface 550 can be coupled to one or more servers using a bus, PCIe, CXL, or DDR. Network interface 550 may be embodied as part of a system-on-a-chip (SoC) that includes one or more processors, or included on a multichip package that also contains one or more processors.

Some examples of network device 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 500 includes one or more input/output (I/O) interface(s) 560. Peripheral interface 570 can include any hardware interface not specifically mentioned above. Peripherals refer generally to devices that connect dependently to system 500. A dependent connection is one where system 500 provides the software platform or hardware platform or both on which operation executes.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processors 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processors 510 or can include circuits or logic in processors 510 and interface 514.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as Non-volatile Memory Express (NVMe) over Fabrics (NVMe-oF) or NVMe.

In some examples, system 500 can be implemented using interconnected compute nodes of processors, memories, storages, network interfaces, and other components. High speed interconnects can be used such as PCIe, Ethernet, or optical interconnects (or a combination thereof).

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Flow diagrams as illustrated herein provide examples of sequences of various process actions. The flow diagrams can indicate operations to be executed by a software or firmware routine, as well as physical operations. In some embodiments, a flow diagram can illustrate the state of a finite state machine (FSM), which can be implemented in hardware and/or software. Although shown in a particular sequence or order, unless otherwise specified, the order of the actions can be modified. Thus, the illustrated embodiments should be understood only as an example, and the process can be performed in a different order, and some actions can be performed in parallel. Additionally, one or more actions can be omitted in various embodiments; thus, not all actions are required in every embodiment. Other process flows are possible.

Example 1 includes one or more examples and includes an apparatus that includes: a semiconductor package comprising: a plurality of cores and a fabric to provide the plurality of cores with access to at least one cache device, wherein: the fabric comprises a group of routers and a plurality of groups of cache controllers, the fabric comprises a group of connections between the group of routers and the plurality of groups of cache controllers, the fabric comprises a second group of connections between cache controllers in a group of cache controllers, and based on receipt of a memory access request from a core of the plurality of cores: a router of the group of routers is to select a group from among the plurality of groups of cache controllers based on the memory access request and forward the memory access request to the selected group and a cache controller in the selected group is to: based on data associated with the memory access request stored in the at least one cache device, service the forwarded memory access request at a selected cache device of the at least one cache device and based on data associated with the memory access request managed by a second cache controller, forward the forwarded memory access request to the second cache controller in the selected group.

Example 2 includes one or more examples, wherein the group of connections and the second group of connections are physically arranged in different directions.

Example 3 includes one or more examples, wherein the memory access request comprises a memory address and identifier of a group of cache controllers of the plurality of groups of cache controllers to which to forward the memory access request.

Example 4 includes one or more examples, and includes the at least one cache device communicatively coupled to the fabric.

Example 5 includes one or more examples, wherein based on a cache miss in the at least one cache device, the second cache controller is to request data associated with the memory access request from a memory device.

Example 6 includes one or more examples, wherein the at least one cache device comprises one or more of: level 1 cache (L1), level 2 cache (L2), level 3 cache (L3), or last level cache (LLC).

Example 7 includes one or more examples, and includes a server, wherein the server comprises the plurality of cores and the fabric.

Example 8 includes one or more examples, and includes a method comprising: in a fabric connected to a plurality of processor cores: based on receipt of a memory access request from a core of the plurality of cores: selecting a group from among a plurality of groups of cache controllers based on the memory access request, forwarding the memory access request to the selected group, based on data associated with the memory access request stored in at least one cache device, servicing the forwarded memory access request at a selected cache device of the at least one cache device, and based on data associated with the memory access request managed by a second cache controller, forward the forwarded memory access request to the second cache controller in the selected group.

Example 9 includes one or more examples, wherein: the fabric comprises a group of routers and the plurality of groups of cache controllers, the fabric comprises a group of connections between the group of routers and the plurality of groups of cache controllers, and the fabric comprises a second group of connections between cache controllers in a group of cache controllers.

Example 10 includes one or more examples, wherein the memory access request comprises a memory address and identifier of a group of cache controllers of the plurality of groups of cache controllers to which to forward the memory access request.

Example 11 includes one or more examples, wherein based on a cache miss in the at least one cache device, requesting data associated with the memory access request from a memory device.

Example 12 includes one or more examples, and includes performing cache coherency to retrieve updated data associated with the memory access request.

Example 13 includes one or more examples, wherein a package is to enclose the plurality of cores and the fabric.

Example 14 includes one or more examples, wherein a router performs the selecting a group from among a plurality of groups of cache controllers based on the memory access request and the forwarding the memory access request to the selected group.

Example 15 includes one or more examples, wherein the selecting a group from among a plurality of groups of cache controllers based on the memory access request comprises selecting an output line to the selected group.

What is claimed is:

1. An apparatus comprising:
a semiconductor package comprising:
a plurality of cores and
a fabric to provide the plurality of cores with access to at least one cache device, wherein:
the fabric comprises a group of routers and a plurality of groups of cache controllers,
the fabric comprises a group of connections between the group of routers and the plurality of groups of cache controllers,
the fabric comprises a second group of connections between cache controllers in a group of cache controllers, and
based on receipt of a memory access request from a core of the plurality of cores:
a router of the group of routers is to select a group from among the plurality of groups of cache controllers based on the memory access request and forward the memory access request to the selected group and
a cache controller in the selected group is to:
based on data associated with the memory access request stored in the at least one cache device, service the forwarded memory access request at a selected cache device of the at least one cache device and
based on data associated with the memory access request managed by a second cache controller, forward the forwarded memory access request to the second cache controller in the selected group.

2. The apparatus of claim 1, wherein the group of connections and the second group of connections are physically arranged in different directions.

3. The apparatus of claim 1, wherein the memory access request comprises a memory address and identifier of a group of cache controllers of the plurality of groups of cache controllers to which to forward the memory access request.

4. The apparatus of claim 1, comprising the at least one cache device communicatively coupled to the fabric.

5. The apparatus of claim 1, wherein based on a cache miss in the at least one cache device, the second cache controller is to request data associated with the memory access request from a memory device.

6. The apparatus of claim 1, wherein the at least one cache device comprises one or more of: level 1 cache (L1), level 2 cache (L2), level 3 cache (L3), or last level cache (LLC).

7. The apparatus of claim 1, comprising a server, wherein the server comprises the plurality of cores and the fabric.

8. A method comprising:
in a fabric connected to a plurality of processor cores:
based on receipt of a memory access request from a core of the plurality of cores:
selecting a group from among a plurality of groups of cache controllers based on the memory access request,
forwarding the memory access request to the selected group,
based on data associated with the memory access request stored in at least one cache device, servicing the forwarded memory access request at a selected cache device of the at least one cache device, and
based on data associated with the memory access request managed by a second cache controller, forward the forwarded memory access request to the second cache controller in the selected group.

9. The method of claim 8, wherein:
the fabric comprises a group of routers and the plurality of groups of cache controllers,
the fabric comprises a group of connections between the group of routers and the plurality of groups of cache controllers, and
the fabric comprises a second group of connections between cache controllers in a group of cache controllers.

10. The method of claim 8, wherein the memory access request comprises a memory address and identifier of a group of cache controllers of the plurality of groups of cache controllers to which to forward the memory access request.

11. The method of claim 8, wherein based on a cache miss in the at least one cache device, requesting data associated with the memory access request from a memory device.

12. The method of claim 8, comprising:
performing cache coherency to retrieve updated data associated with the memory access request.

13. The method of claim 8, wherein a package is to enclose the plurality of cores and the fabric.

14. The method of claim 8, wherein a router performs the selecting a group from among a plurality of groups of cache controllers based on the memory access request and the forwarding the memory access request to the selected group.

15. The method of claim 8, wherein the selecting a group from among a plurality of groups of cache controllers based on the memory access request comprises selecting an output line to the selected group.
